(19) United States
(12) Patent Application Publication
(10) Pub. No.: US 2025/0075462 A1
(43) Pub. Date: Mar. 6, 2025

(54) CABLESS DUMPER

(71) Applicant: Oshkosh Corporation, Oshkosh, WI (US)

(72) Inventors: Zeno Poltronieri, Oshkosh, WI (US); Davide Boroni, Oshkosh, WI (US); Roberto Marchesini, Oshkosh, WI (US); Riccardo Piovan, Oshkosh, WI (US)

(73) Assignee: Oshkosh Corporation, Oshkosh, WI (US)

(21) Appl. No.: 18/822,044

(22) Filed: Aug. 30, 2024

Related U.S. Application Data
(60) Provisional application No. 63/535,956, filed on Aug. 31, 2023.

(51) Int. Cl. E02F 3/348; E02F 9/20; E02F 9/24

(52) U.S. Cl. CPC E02F 3/3486; E02F 9/205; E02F 9/24

(57) ABSTRACT

A self-propelled cart which receives control signals from a remote electronic device. In some embodiments, the dumper includes a top portion and a lower portion, wherein the top portion and the bottom portion are rotatably coupled by a rotating member such that the top portion rotates independent of the base. In some embodiments, the top portion may rotate 360° about a vertical axis of the base. In one implementation, the dumper does not have a cab or onboard control station.

### CROSS-REFERENCE TO RELATED PATENT APPLICATION

This application claims the benefit of and priority to U.S. Provisional Patent Application No. 63/535,956, filed Aug. 31, 2023, the entire disclosure of which is incorporated by reference herein.

### BACKGROUND

The present disclosure generally relates to work vehicles. Onboard operator controls and operator cabs constrain payload capacity, vehicle maneuverability, and component placement of work vehicles.

### SUMMARY

In one implementation of the present disclosure, a work vehicle is remotely operated by an electronic device that is configured to transmit one or more control signals to the work vehicle. Due to the remote operation capabilities of the work vehicle, an onboard operator station and/or controls (e.g., an operator cab) may be removed from the vehicle. With the removal of the onboard operator station and/or controls, a dump body of the work vehicle may be larger (by encompassing the volume previously taken up by the onboard operator station and/or controls). In addition, the removal of the onboard operator station and/or controls allows the dump body to rotate completely about a vertical axis of the work vehicle. Electrical and structural componentry of the onboard operator station and/or controls may be completely removed and/or repositioned to the base of the work vehicle for a lower center of gravity, increased stability, additional protection, and increased space optimization.

In some aspects, the techniques described herein relate to a system including: self-propelled cart including: a chassis; a body pivotally coupled to the chassis and configured to contain a volume of material; an actuator configured to cause the body to rotate 360° relative to the chassis in a direction; a tractive element coupled to the chassis; a motor configured to drive the tractive element to propel the self-propelled cart; and a controller operatively coupled to the motor and the actuator; and a user device, wherein the user device is configured to transmit a control signal to the controller in response receiving instructions from an operator interface, and wherein the controller is configured to activate at least one of the actuator or the motor in response to receiving the control signal.

In some aspects, the techniques described herein relate to a system, wherein the user device is configured to transmit the control signal wirelessly to the controller of the self-propelled cart to remotely control the self-propelled cart.

In some aspects, the techniques described herein relate to a system, wherein the self-propelled cart is a buggy for loading and unloading construction material.

In some aspects, the techniques described herein relate to a system, wherein the self-propelled cart does not include manual controls onboard the self-propelled cart.

In some aspects, the techniques described herein relate to a system, wherein the tractive element is one of a tread, wheel, and track.

In some aspects, the techniques described herein relate to a system, wherein the self-propelled cart further includes a bucket coupled to a bottom portion of the body, the bucket configured to rotate relative to the body.

In some aspects, the techniques described herein relate to a system, wherein the self-propelled cart further includes a second actuator configured to rotate the body relative to the chassis in a second direction, wherein the second direction provides for dumping of the volume of material out of the body.

In some aspects, the techniques described herein relate to a system, wherein the user device is a handheld remote control configured to remotely control one or more actions of the self-propelled cart.

In some aspects, the techniques described herein relate to a system, wherein the self-propelled cart further includes; an ignition for initiating power to the self-propelled cart; and an emergency shut-off control to override the ignition and remove power to the self-propelled cart.

In some aspects, the techniques described herein relate to a system, wherein the self-propelled cart further includes a slew ring coupling the body to the chassis, the slew ring configured to allow the body to rotate 360° about the chassis.

In some aspects, the techniques described herein relate to a system, wherein the self-propelled cart further includes a battery positioned below the body of the self-propelled cart and configured to provide power to the self-propelled cart.

In some aspects, the techniques described herein relate to a system, the self-propelled cart further including a second tractive element, wherein the battery is positioned between the tractive element and the second tractive element.

In some aspects, the techniques described herein relate to a self-propelled cart including: a chassis; a body pivotally coupled to the chassis and configured to contain a volume of material; an actuator configured to cause the body to rotate 360° relative to the chassis in a direction; a tractive element coupled to the chassis; a motor configured to drive the tractive element to propel the self-propelled cart; and a controller operatively coupled to the motor and the actuator.

In some aspects, the techniques described herein relate to a self-propelled cart, the self-propelled cart further including a second tractive element, wherein a battery for providing power to the self-propelled cart is positioned between the tractive element and the second tractive element.

In some aspects, the techniques described herein relate to a self-propelled cart, wherein the self-propelled cart does not include manual controls onboard the self-propelled cart.

In some aspects, the techniques described herein relate to a self-propelled cart, wherein the self-propelled cart further includes a bucket coupled to a bottom portion of the body, the bucket configured to rotate relative the body.

In some aspects, the techniques described herein relate to a self-propelled cart, wherein the self-propelled cart further includes a second actuator configured to rotate the body relative to the chassis in a second direction, wherein the second direction provides for a dumping of the volume of material out of the body.

In some aspects, the techniques described herein relate to a self-propelled cart, wherein the self-propelled cart further includes; an ignition for initiating power to the self-propelled cart; and an emergency shut-off control to override the ignition and remove power to the self-propelled cart.

In some aspects, the techniques described herein relate to a self-propelled cart, wherein the self-propelled cart further includes a slew ring coupling the body to the chassis, the slew ring configured to allow the body to rotate 360° about the chassis.

In some aspects, the techniques described herein relate to a self-propelled cart including: a chassis; a body pivotally coupled to the chassis and configured to contain a volume of material; a slew ring pivotally coupling the body to the chassis; an actuator configured to cause the body to rotate 360° relative to the chassis in a direction; a tractive element coupled to the chassis; a motor configured to drive the tractive element to propel the self-propelled cart; and a controller operatively coupled to the motor and the actuator.

The systems and methods described herein are capable of other embodiments and of being carried out in various ways. Alternative exemplary embodiments relate to other features and combinations of features as may be recited herein.

### BRIEF DESCRIPTION OF THE FIGURES

FIGS. 1A-1H are perspective views of a remotely operated vehicle, according to an exemplary embodiment.

FIG. 1I is a top view of the remotely operated vehicle of FIG. 1A.

FIG. 1J is a side-view comparison of the remotely operated dumper of FIG. 1A and an onboard-operated dumper, according to an exemplary embodiment.

FIG. 1K is a picture representation of various views of the remotely operated dumper of FIG. 1A including a side view, a rear view, and a top view.

FIG. 2 is a perspective view of a lower portion of the remotely operated dumper of FIG. 1A.

FIG. 3 is a section view of the remotely operated dumper of FIG. 1A.

FIG. 4 is a perspective view of the remotely operated dumper of FIG. 1A.

FIG. 5 is a perspective view of the remotely operated dumper of FIG. 1A.

FIGS. 6A-6D are perspective views of the lower portion of FIG. 2.

FIGS. 7A and 7B are exploded views of the lower portion of FIG. 2.

FIG. 8 is a perspective view of the lower portion of FIG. 2.

FIG. 9 is a top view of a user device for operating the remotely operated dumper of FIG. 1A.

FIG. 10 is a schematic representation of a vehicle and associated electronic componentry, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

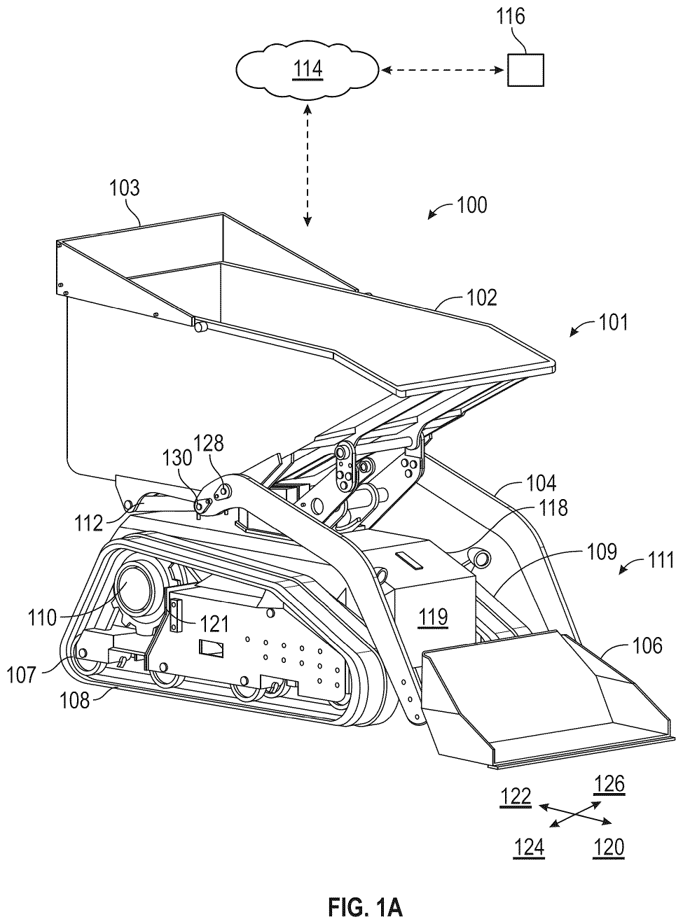

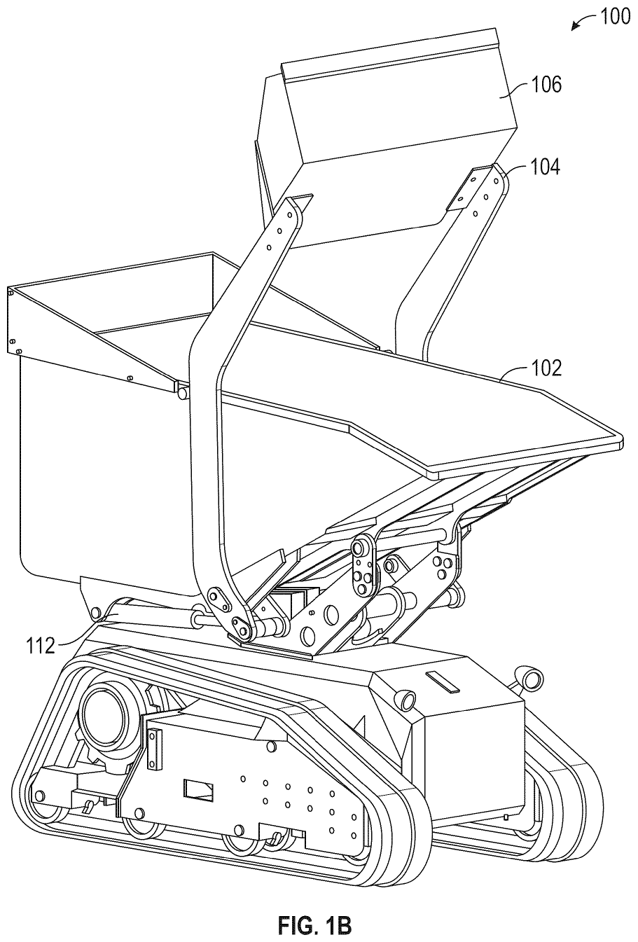

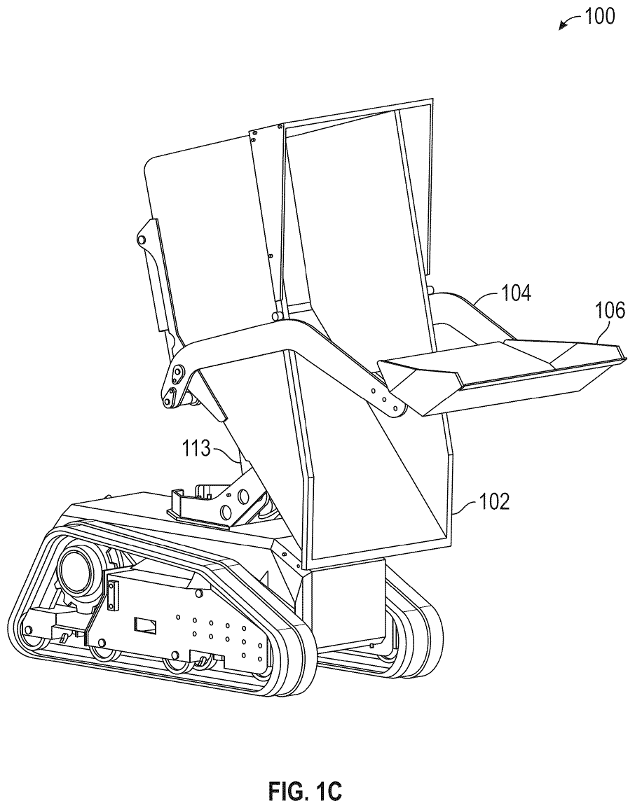

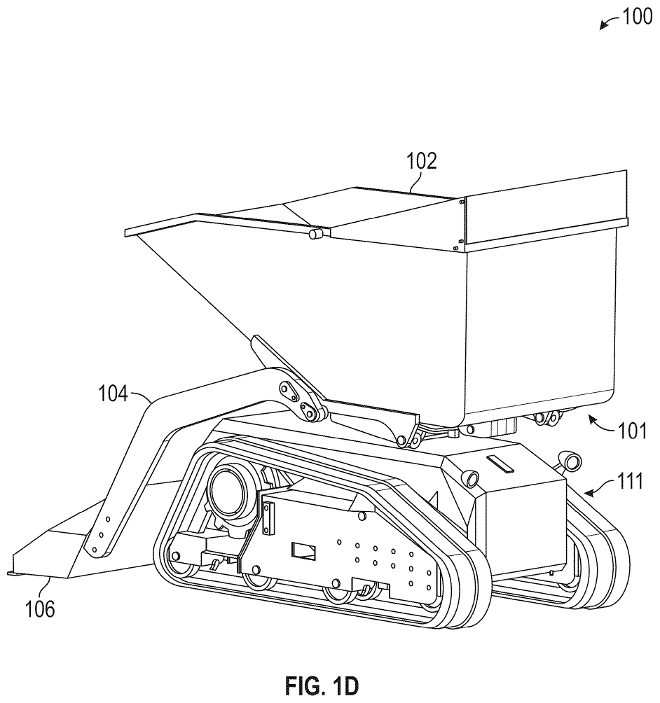

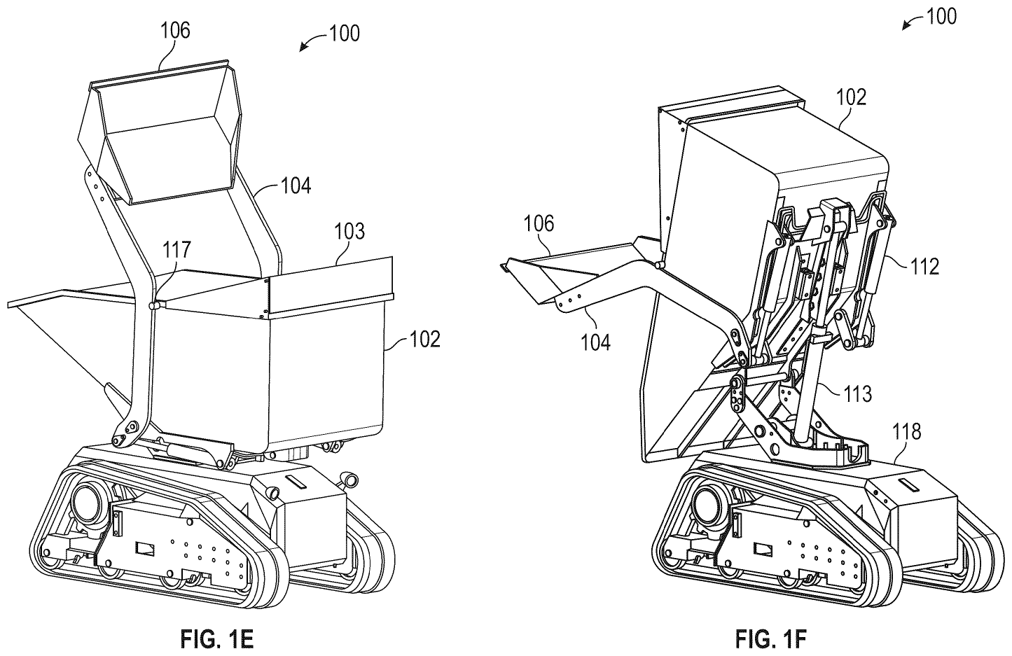

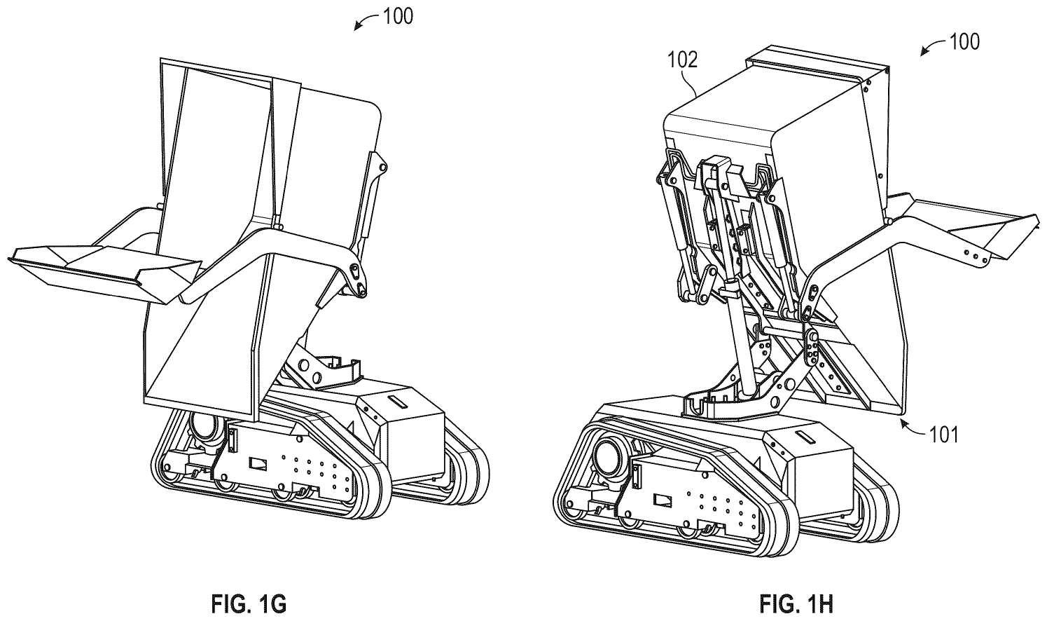

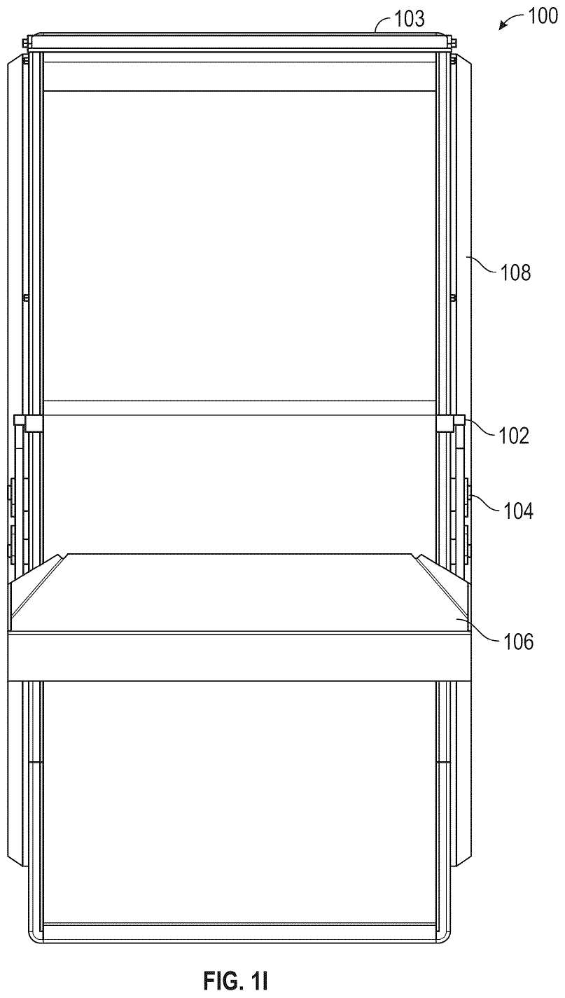

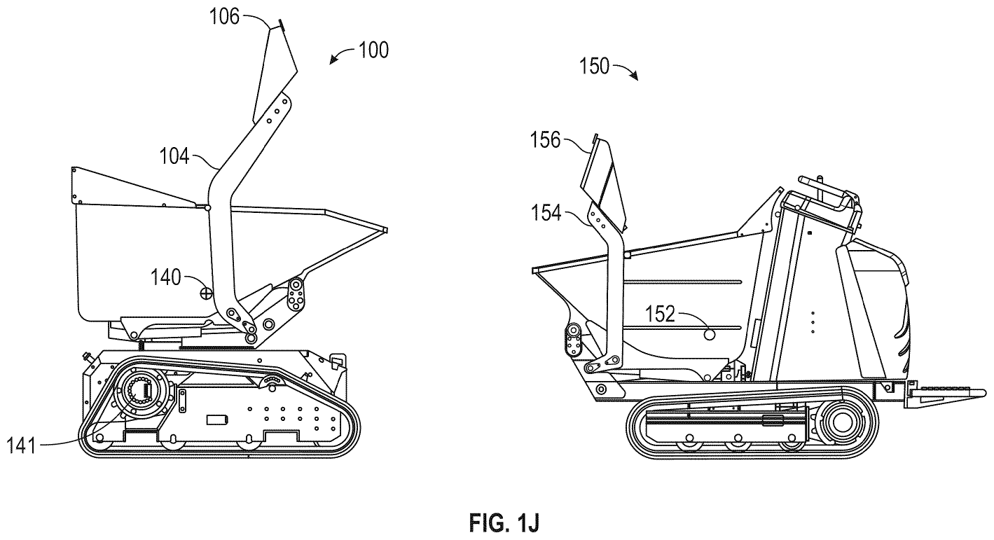

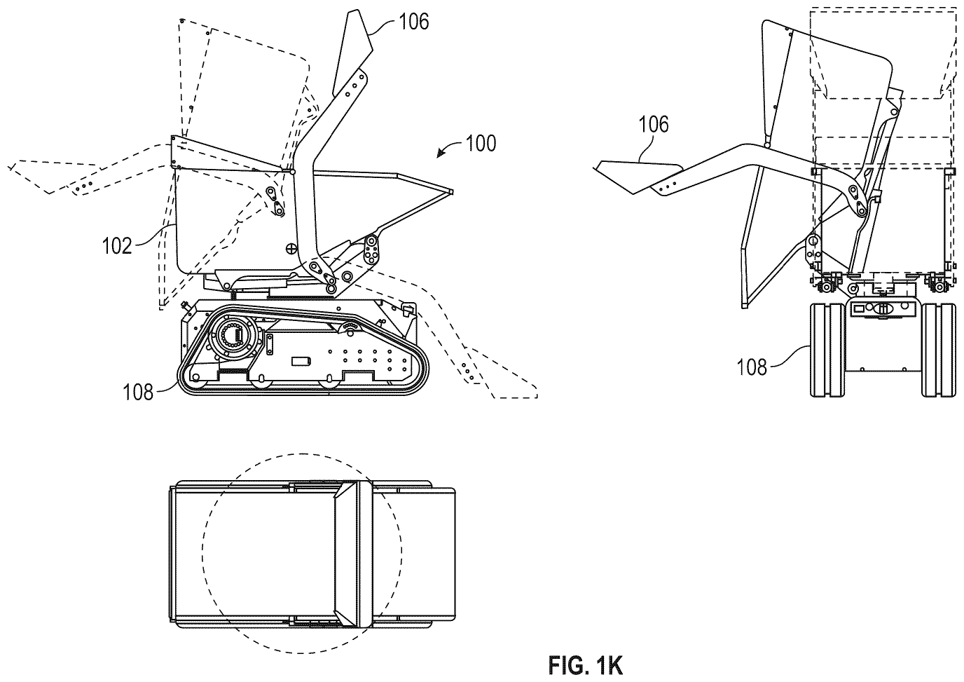

Referring to the figures generally, the various exemplary embodiments disclosed herein relate to systems, apparatuses, and methods for remotely operated construction vehicles. In one exemplary embodiment, a dumper is shown in the various figures described herein. However, it should be noted that the concepts and inventive elements in the present disclosure may be applied to any vehicle including, but not limited to, forklifts, excavators, bulldozers, loaders, dump trucks, backhoe loaders, graders, cranes, skid steer loaders, and tractors. Dumpers are used in various construction environments to load, move, and dump material from a first location to a second location. Turning now to FIGS. 1A-1K, an exemplary dumper is shown.

In FIG. 1A, a vehicle 100 (e.g., a cabless, electrically-powered, remote-controlled mini-dumper, a dumper, a work machine, self-propelled cart, buggy, etc.) is shown according to an exemplary embodiment. The vehicle 100 may be configured for loading and unloading construction material (e.g., construction media, sand, dirt, rocks, coal, minerals, water, mud, metal, wood, biomaterial, etc.). The vehicle 100 may include several distinct components. In one implementation the vehicle 100 may include an upper portion 101 and a lower portion 111. The upper portion 101 may include a dump body 102, a guard 103, a bucket 106, one or more bucket arms 104, one or more bucket actuators 112, and one or more dump actuators 113 (as shown in FIGS. 1C and 1F). In some embodiments the upper portion 101 includes more, less, or different components than listed above. The lower portion 111 may include a base 118 (e.g., a chassis), one or more tractive elements 108, a drive unit 110, and one or more component guards 119. While the upper portion 101 and the lower portion 111 may include a cab or operator station, in an exemplary embodiment, the vehicle 100 does not include a cab or operator station. Indeed, in some embodiments, the vehicle 100 does not include manual controls for controlling mobile operation of the vehicle 100 onboard the vehicle 100. Instead, the dumper is controlled by a user device 116 (e.g., a handheld remote control, mobile device, computing device, etc.). When describing the vehicle 100, the terms forward 120, backward 122, right 124, and left 126 may be used for ease of understanding, however, it should be noted that these directions are in no way limiting of the present disclosure and are used for case of understanding.

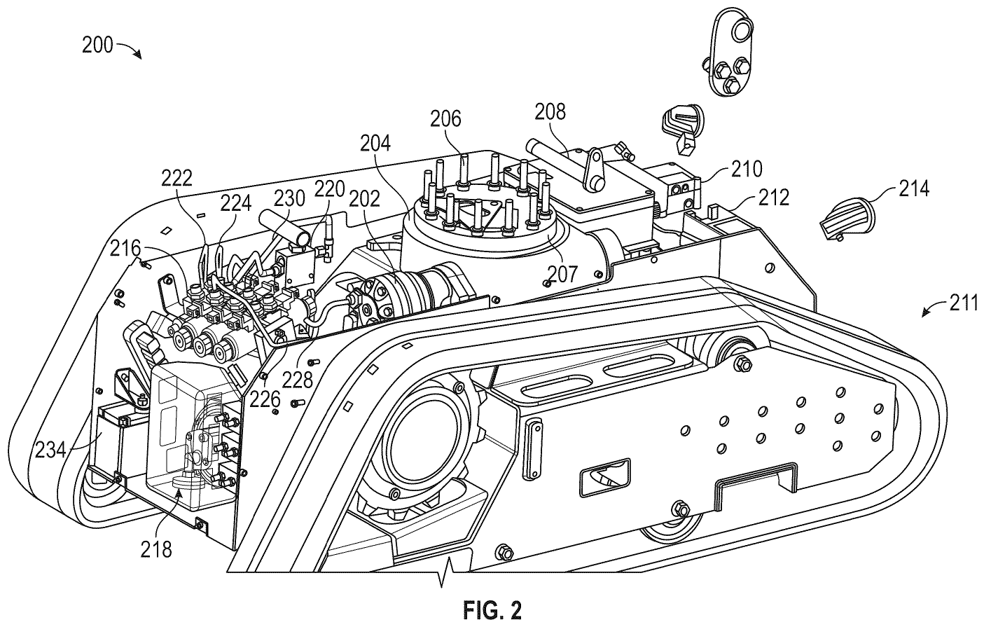

According to an exemplary embodiment, the upper portion 101 and the lower portion 111 may rotate about a vertical axis of the vehicle 100 independently of each other. For example, the lower portion 111 may include one or more actuators to pivot the upper portion 101 about the lower portion 111, as described in greater detail in FIG. 2.

In some embodiments, the vehicle 100 may be communicatively coupled to the user device 116 through one or more communication protocols or interfaces. According to some embodiments, the communication protocol or interface may be through LAN, USB, Bluetooth (registered trademark), Wi-Fi, 5G, NFC, cellular communication, satellite communication, etc. In some embodiments, the user device 116 may be communicatively coupled to the vehicle 100 through a network 114. An operator may use the user device 116 to remotely control the vehicle 100 at a distance. Remote operation of the vehicle 100 increases safety of the operator because it removes the possibility of the operator falling off the vehicle 100, getting pinched/crushed by rotating or moving parts, or being hit by material being loaded or unloaded from the vehicle 100. Removal of the operator also reduces operator fatigue because the operator does not need to be constantly maintaining balance during the movement of the vehicle 100. Additionally, the operator may be sitting or placed in the shade to avoid extra exertion. This allows the operator to focus on the operating the vehicle 100 and not on exhaustion. Likewise, by removing the operator from the vehicle 100, the operator is able to operate multiple vehicles 100 without being constrained to a specific location.

In some embodiments, the user device 116 can send control signals to the vehicle 100 to transmit instructions to operate the vehicle 100. The control signals are received by the vehicle 100 and further transmitted to one or more subsystems of the vehicle 100 (e.g., hydraulic, electric, drive, suspension) to execute the instructions. In some embodiments, the vehicle 100 includes electronic componentry to translate the transmitted control signals to readable instructions for the one or more subsystems of the vehicle 100. In some embodiments, the user device 116 and/or the vehicle 100 are aware of the each's corresponding location/position. For example, the user device 116 may receive data associated with the dumper's 100 location and/or the user device's 116 location. Likewise, the vehicle 100 may receive data associated with the dumper's 100 location and/or the user device's 116 location. This information may be used and transmitted between the various components of the disclose system to adjust the operating parameters of the vehicle 100 or the user device 116. By way of example, the vehicle 100 may only be able to be operated if the user device 116 is positioned beyond a predefined minimum distance threshold. Alternatively/additionally, the vehicle 100 may only be operated if the user device 116 is within a predefined maximum distance threshold. In such embodiments, the operator is required to be within a certain distance of the vehicle 100 in order to visually observe the dumper's 100 actions. This may ensure that the operator of the dumper is not in danger of hurting themselves and/or others by operating the vehicle 100 without visually observing the vehicle 100 during operation. In some embodiments, workers in the proximity of the vehicle 100 may wear/carry a device (e.g., a location beacon, mobile device, tablet, laptop, etc.) that transmits data associated with their location to the dumper and/or the user device. These data associated with various worker locations may be used to adjust one or more operating parameters (e.g., speed, direction of travel, dumping capabilities, power state, rotation dump body 102, etc.) of the dumper or functionality of the user device 116 (e.g., ability to transmit instructions or control signals) to avoid worker injury.

By way of example, if a worker carrying a location beacon (or user device 116) enters an area proximate the vehicle 100, one or more operating parameters vehicle 100 may be limited to avoid injury. This limit may include completely stopping any function of the vehicle 100 (e.g., it cannot move), or the limit may include reducing the max speed of the vehicle 100, dumping abilities of the dump body 102, specific travel of direction of the dumper. For example, if the worker is positioned forward of the vehicle 100, the vehicle 100 may be limited to moving backward 122, left 126, and/or right 124. In some embodiments, the user device 116 may be the location beacon. In some embodiments, the vehicle 100 shuts down when the worker enters the area proximate the vehicle 100.

In some embodiments, the user device 116, instead of the vehicle 100, is limited when a worker is within the area proximate the vehicle 100. In contrast to the vehicle 100 being limited, in this embodiment the user device 116 is limited from transmitting control signals to the vehicle 100. For example, the user device 116 may be limited from sending control signals to the vehicle 100. Alternatively, or in addition, the user device 116 may be limited only to sending signals that do not put the worker in danger (e.g., lowered speeds, limiting direction of travel, limiting dumping capabilities, etc.).

The bucket 106 is configured to pivot about the dump body 102 so as to load the dump body 102 with material (e.g., construction media, sand, dirt, rocks, coal, minerals, water, mud, metal, wood, biomaterial, etc.). For example, the one or more bucket actuators 112 may be used to pivot the one or more bucket arms 104. The bucket arm 104 may be coupled (e.g., pivotably or fixedly) to the bucket actuator 112 at a pivot point 130, the pivot point 130 located at a first end of the bucket arm 104. The bucket arm 104 may be coupled (e.g., pivotably or fixedly) to a bottom portion of the bucket 106 at a pivot point 128. In some embodiments, the bucket arm 104 may be coupled to the bucket 106 and the bucket actuator 112 at the same end and be configured to pivot about another point. The bucket 106 is configured to rotate, by means of the bucket arms 104, between a first position (level with the supporting surface of the vehicle 100) and a second position (an elevated position to dump loaded material into the dump body 102).

The bucket actuator 112 may be any actuator able to rotate or otherwise move the bucket arm 104. In a more specific embodiment, the bucket actuator 112 may be any actuator able to move the bucket arm 104 for loading and unloading material from the bucket 106 into the dump body 102. One or more bucket actuators 112 may be used and can include (but are in no way limited to) hydraulic cylinders, linear actuators, electric motors, and/or pneumatic cylinders. Necessary components to drive the various actuators (e.g., the bucket actuator 112) onboard the vehicle 100 may be housed entirely in the lower portion 111, the upper portion 101, or distributed between the lower portion 111 and the upper portion 101. In some embodiments, one or more component guards 119 may be used to protect electronic and drive components of the vehicle 100.

The lower portion 111 of the vehicle 100 may include one or more drive units 110 to drive the one or more tractive elements 108. In some embodiments, the one or more tractive elements 108 are structured as wheels. In other embodiments, such as illustrated in FIG. 1A, the tractive elements 108 are structured as tracks. In yet other embodiments, the tractive elements 108 may be structured as a tread. It is noted that the tractive elements 108 may be an combination of structures, including wheels, treads, and/or tracks. Tractive elements 108 of FIG. 1A are driven by the drive unit 110 which may be an electric motor, a hydraulic motor, a pneumatic motor, an internal combustion engine, etc. In some embodiments, the drive unit 110 is a gear (or other mechanical interface) which is operatively coupled to the electric motor, the hydraulic motor, the pneumatic motor, the internal combustion engine, etc. The drive unit 110 may be configured to rotate in a first direction to travel forward 120. The drive unit 110 may be configured to rotate in a second direction to travel backward 122. The tractive elements 108 may be configured to pivot to allow the vehicle 100 to steer. In other embodiments, the vehicle 100 may include more than one tractive element 108 that work in tandem to steer the vehicle 100. For example, a first tractive element 108 may rotate in the first direction while a second tractive element 109 rotates in a second direction to turn the vehicle 100.

The one or more tractive elements 108 may propel the vehicle 100 forward 120, backward 122, left 126, and right 124. in one exemplary embodiment, the one and more tractive elements 108 propel the vehicle 100 forward to engage the bucket 106 with a loading material (e.g., rocks, sand, dirt, grass, leaves, concrete, gravel, water, mud, etc.).

In an exemplary embodiment, the tractive elements 108 may have a track width of approximately 180 mm, approximately three fixed inferior track rollers 107 on each side of the vehicle 100, approximately one superior track roller 121 on each side of the vehicle 100, an internal guide with bearings/grease track tensioning system for an idler/track tensioning system, and a negative brake in a motor gearbox of the vehicle 100.

By removing the cab or operator station, the volume of the dump body 102 may be optimized/maximized for a given footprint of the lower portion 111. Without the cab or operator station, the volume of the dump body 102 may include the volume taken by the cab or operator station in traditional dumpers. In at least one exemplary embodiment, the vehicle 100 may be optimized to pass through a standard door frame (e.g., by maintaining a total width of the vehicle 100 less than a width of the standard door frame). Without an operator station or cab, the vehicle 100 may increase load capacity while still maintaining a footprint that allows the vehicle 100 to pass through the standard door frame. This optimization of load capacity may be in terms of weight capacity (because there is no longer the need to carry an operator and the corresponding controls), dump body 102 length/overall length (because the operator is no longer taking up space on the vehicle 100), absolute volume, dump body 102 volume/width, etc. Likewise, the center of gravity may be optimized to a lowest position based on loaded dump body 102 and/or based on wheelbase. In one exemplary embodiment of the vehicle 100, the operating weight of the vehicle 100 is approximately 665 kg with a max load capacity of approximately 925 kg. In an exemplary embodiment, the max travel speed in a first mode is approximately 2 km/h, while a max travel speed in a second mode is approximately 4 km/h. In an exemplary embodiment of the vehicle 100, the struck volume may be approximately 0.39 m³ and a total capacity of 0.46 m³.

Additionally, by removing the cab or operator station from the vehicle 100, the dump body 102 may rotate to load/dump in 360° while maintaining a maximized load volume of the dump body 102. As described herein, operator safety is increased with the removal of the cab or operator station from the vehicle 100.

Turning now to FIG. 1B, the vehicle 100 is illustrated in a first configuration (e.g., loading). In the first configuration, the bucket actuators 112 are extended and/or retracted so as to pivot the one or more bucket arms 104 above the dump body 102. While the bucket arms 104 are shown in FIG. 1B as pivoting about a single point, it should be noted and understood that the one or more bucket arms 104 may be comprised of several linkages and/or components and configured to rotate about more than one pivot point. Additionally, the one or more bucket actuators may couple to the one or more bucket arms 104 and bucket 106 at several locations to facilitate articulation of the bucket arms 104 and bucket 106.

In the first configuration of FIG. 1B, the bucket 106 is in a position so as to load the dump body 102 with any material loaded in the bucket 106. In some embodiments, however, the vehicle 100 does not include a bucket 106. In such embodiments, the vehicle 100 is manually loaded by one or more workers or one or more vehicles (e.g., front loaders, skid-steers, backhoe, tractor, snowplow, bailer, auger, conveyer, etc.). Alternatively, the bucket arms 104 may be coupled to an implement other than a bucket 106 (e.g., fruit picker, blade, claw, magnet, work platform, etc.). In these alternative embodiments, when the bucket arms 104 are elevated in the first configuration, the alternative to the bucket 106 (e.g., fruit picker, blade, claw, magnet, etc.) may execute a subsequent action to load the dump body 102 (e.g., opening a chute, demagnetizing a magnet, releasing a claw, etc.).

In other embodiments, the first configuration of FIG. 1B need not be dropping material into the dump body 102. By way of example, the dump body 102 may be fully or partially enclosed with doors, which may open for loading. In such embodiments, the doors of the dump body 102 may open and the bucket arms 104 may articulate in a way to load the load material into the dump body 102 through the dump body 102 doors.

Additionally, in other embodiments, the dump body 102 may include more, less, or different components than illustrated in FIG. 1B. For example, the dump body 102 may be a platform with no walls, one wall, or more than one wall.

In another exemplary embodiment, the vehicle 100 may be used to deploy solar panels for energy production. By way of example, the bucket 106 may be replaced with an array of one or more solar panels. The bucket arms 104 may be restructured or adjusted to deploy the array of one or more solar panels. For example, the array of solar panels may be a compliant mechanism or may be folded for transport (e.g., loaded in a storage compartment). Upon deploying the array of solar panels (e.g., unfolding), the vehicle 100 may rotate the upper portion 101 to position the array of solar panels to maximize sun exposure and thus energy production. The arms 104 or dump body 102 (which, in some embodiments, may also be a platform or the solar panel array) may tilt or adjust the position of the array of solar panels to face the sun based on data received by one or more sensors (e.g., photon receptors). Additionally, the vehicle 100 may automatically or manually adjust its ground location to maximize solar power production (e.g., moving from one position to a second position). In some embodiments, the vehicle 100 automatically moves its position based on sensor data received from one or more sensors (e.g., photon receptor). The produced solar power may be stored in one or more energy storage devices (e.g., battery cells). In some embodiments, the energy is stored in one or more battery cells used to operate the vehicle 100. In other embodiments, the vehicle 100 has a dedicated energy storage device for produced solar power. The vehicle 100 may include various electrical converters and componentry to convert the generated solar power to a storable energy medium.

For example, the solar panels may use photovoltaic (PV) panels, which may use semiconductor materials that generate electricity when exposed to sunlight. These panels contain numerous solar cells that convert photons from sunlight into a flow of electrons, creating direct current (DC) electricity. To store this energy for use when the sun isn't shining, the DC electricity is directed to an inverter to convert the DC electricity to alternating current (AC) electricity. This AC electricity can be used to power the vehicle 100, or other electrically coupled devices (e.g., other vehicles, tools, batteries, buildings, etc.). However, to store excess solar energy for later use, such as during nighttime or cloudy periods, the converted AC electricity is directed towards a battery storage system.

The battery storage system aids converting and storing surplus energy efficiently. In some embodiments, these systems comprise lithium-ion batteries. The AC electricity from the inverter is further transformed and stored as DC electricity in the batteries. The vehicle 100 may include a battery management system to monitor the state of charge and health of the battery cells. When electricity is required, the battery storage system's inverter may convert the stored DC electricity back into AC electricity, which can be used to power the vehicle 100. In other embodiments, the vehicle 100 uses DC electricity, which may eliminate the need to convert the stored DC electricity to back into AC electricity.

Turning now to FIG. 1C, the vehicle 100 is shown in a second configuration. In the second configuration, the one or more dump actuators 113 are actuated to extend and/or retract so as to position the dump body in a position to dump any loaded material in the dump body 102 on an area proximate the vehicle 100. In some embodiments, the bucket 106 is positioned so as to not interfere with the support surface (e.g., the ground) of the vehicle 100 during the second configuration. The second configuration may pivot the dump body 102 to elevate a portion of the dump body 102 and cause any loaded material to fall from the dump body 102. In one or more additional and/or alternative embodiments, the dump actuator 113 may cause the loaded material to exit the dump body 102 without pivoting the dump body 102. For example, the dump actuator 113 may be coupled to a push plate that, when actuated by the dump actuator 113, exerts a force against the loaded materials and causes the loaded materials to exit the dump body.

Turning now to FIG. 1D, the vehicle 100 is illustrated with the dump body pivoted about a vertical axis of the vehicle 100 and facing backward 122 (as described in FIG. 1A). Because the cab and/or operator station of the vehicle 100 is removed from the vehicle 100, the upper portion 101 is able to pivot about the lower portion 111 independently. This increases the functionality of the vehicle 100 as it can access (e.g., load from and/or dump on) the area completely surrounding the vehicle 100.

In FIG. 1D, the bucket 106 is placed on the support surface of the vehicle 100. In some embodiments, the bucket arms 104 are rotated to position the bucket lower than the support surface of the vehicle 100.

Turning now to FIG. 1E, the vehicle 100 is shown in the first configuration facing backward 122 (as described in FIG. 1A) in which the bucket 106 is pivoted into a position superior the dump body 102 by the one or more bucket arms 104. In some embodiments there exists a physical stop 117 to prevent the bucket arms 104 from rotating beyond a predefined location. The guard 103 may be used to prevent material being loaded during the first configuration shown in FIG. 1E. According to an embodiment, the guard 103 may be retracted to uncover and deployed to cover the material loaded in the dump body 102.

Turning now to FIG. 1F, the vehicle 100 is shown in the second configuration facing backward 122 (as described in FIG. 1A). Again, during the second configuration, the bucket arms 104 and the bucket 106 may be pivoted/positioned so as to not interfere with the vehicle 100 or the support surface of the vehicle 100. The dump actuator 113 is shown in an extended position, thereby lifting one end of the dump body 102 and causing any loaded material to dump from the dump body. It should be understood that in some embodiments, the dump actuator 113 is retracted to lift one end of the dump body 102. As shown in FIG. 1F, the dump body 102 is coupled to a single dump actuator 113. However, it should be appreciated that the dump body 102 may be coupled to one or more dump actuators 113, and that the dump body 102 may be configured to dump in more than one direction (e.g., by alternatively lifting different ends of the dump bucket while in a single orientation).

FIG. 1G illustrates the vehicle 100 in the second configuration facing right 124 (as described in FIG. 1). FIG. 1H illustrates the vehicle 100 in the second configuration facing left 126 (as described in FIG. 1A). It should be understood that while FIGS. 1A-1H illustrate the vehicle 100 facing forward 120, backward 122, right, 124, and left 126 (as described in FIG. 1A), the vehicle 100 may include systems and methods to rotate the upper portion 101 360 degrees about the lower portion 111. In some embodiments, certain predefined positions may be defaulted as dump positions (e.g., FIG. 1C, F-H) for preset dumping procedures. In some embodiments, the upper portion 101 may be rotated at any angle relative to the lower portion 111.

Turning now to FIG. 1I, a top view of the vehicle 100 is shown. The bucket 106 is positioned by the bucket arms 104 above the dump body 102 in a first configuration. In some embodiments, the tractive elements 108 extend beyond a width of the dump body 102 for increased stability. In other embodiments, the dump body 102 extends beyond a width of the vehicle 100 footprint for increased volume capacity. In some embodiments, the dump body 102 is the same width as the vehicle 100 footprint.

Turning now to FIG. 1J, a comparison of a remotely operated vehicle 100, with a 360-degree rotation ability, and an operator operated vehicle 150, with a 180-degree rotation ability. In some embodiments, the center of gravity 140 of the of the vehicle 100 is higher than the center of gravity 152 of the vehicle 150. However, with an operator mounted on the vehicle 150, the center of gravity 152 of the vehicle 150 may be shifted vertically upwards to be higher than the center of gravity 140 of the vehicle 100. Additionally, the center of gravity 140 of the vehicle 100 may be higher while in the first configuration (as shown in FIG. 1J) because the bucket arms 104 of vehicle 100 are longer than the one or more bucket arms 154 of the vehicle 150, thus placing the bucket 106 higher than the bucket 156.

As shown in FIG. 1J, in some embodiments, in the first configuration, the center of gravity 140 of vehicle 100 may be approximately 795 mm above the support surface of the vehicle 100 and 315 mm forward from a drive unit 141 of the vehicle 100. This positioning may provide increased stability and maneuverability of the vehicle.

Turning now to FIG. 1K, various exemplary dimensions are depicted for the vehicle 100. As shown in FIG. 1K, the vehicle 100 may have a width of about 780 mm, which may facilitate entry through standard doorway openings (e.g., 800 mm). In some embodiments, the vehicle 100 may have a ground clearance of about 108 mm, which may facilitate maneuvering over objects on the ground (e.g., debris, rocks, wood, construction materials, etc.). In some embodiments, the vehicle 100 may have a total height (e.g., from ground to a bucket 106 in the first configuration) of about 2082 mm. In some embodiments, the vehicle 100 may have a tractive element length of 1362.5 mm, which may facilitate maneuverability within buildings, at construction sites, and/or outdoors. The vehicle 100 may have a total length (e.g., from back of the dump body 102 to the front end of the bucket 106) of about 1990 mm. When dumping laterally, the vehicle 100 may have a standout distance (e.g., distance from the tractive element 108 to the front tip of the bucket 106) of approximately 1174 mm.

Turning now to FIG. 2, the internal componentry of a vehicle 200 is shown with an upper portion (e.g., upper portion 101 of FIG. 1A) removed from view. In some embodiments, the vehicle 200 is substantially similar to the vehicle 100. The vehicle 200 may include one or more lights 214 (e.g., LEDs, halogen lights, fluorescent lights, infrared lights, etc.), an electric charger 212 (e.g., an electrical port, a wireless charging device, etc.), a modem 210, a receiver 208, one or more dump body fasteners 206 (e.g., bolts, rivets, screws, welds, etc.), a rotatable coupler 204 (e.g., a slew ring), a drive motor 202, a hydraulic control valve 216, one or more hydraulic lines 222, 224, 230, 226, 228, a first battery 234 (e.g., a 12V battery or other low voltage battery), and a power module 218.

In some embodiments, the vehicle 200 is an electric vehicle with a low (e.g., 12 V) and/or high (e.g., 48 V) voltage battery for propelling the vehicle 200. In one embodiment, the nominal voltage of the battery/batteries may be 120 Ah. The low and/or high voltage battery may be used individually or in combination to power all or some of the electronics and actuators onboard the vehicle 200. In some embodiments, various filters and voltage converters/inverters are included in the vehicle 200 and coupled to the various high/low voltage batteries and electronics to provide a required voltage within a specified range to the electronics. The electric charger 212 may be a plug that may be used to charge one or all high/low voltage batteries when coupled to an external charging port. The electric charger 212 may have an electrical/physical interface consistent with one or more standardized charging platforms (e.g., SAE J1772, Mennekes, CHAdeMO, CCS, NACS, or a proprietary plug).

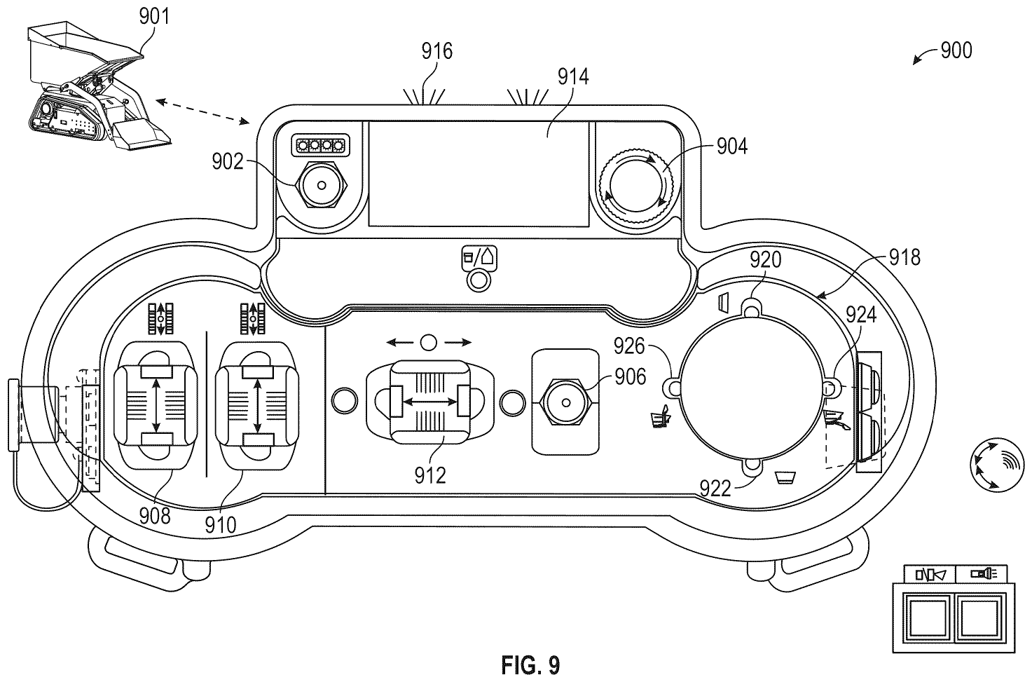

The modem 210 may be any device used to translate data from one format to another format. According to an embodiment, the modem 210 translates data received by the receiver 208 into data/information that may be used by the onboard componentry of the vehicle 200. For example, the receiver 208 may receive, wirelessly or by wire, data from a user device (e.g., user device 900 of FIG. 9). This data may be control signals sent from the user device, sent to control the vehicle 200. The receiver 208 may have one or more antennas to receive wireless communication data over wireless transmission. This captured/received data is then transmitted (by wire or wirelessly) to the modem 210. The modem 210 then may translate the transmitted data into a format readable by the various components onboard the vehicle 200.

The rotatable coupler 204 may be a slew ring. The slew ring, also known as a slewing bearing or turntable bearing, may be a proprietary component or off-the-shelf component. The slew ring may be comprised of two concentric rings: a first ring that attaches to the chassis or stationary portion of the vehicle 200 (e.g., a lower portion 211) and a second ring 207 that connects to the rotating portion (e.g., the unshown upper portion). These rings may be connected by a set of ball or roller bearings that allow smooth and controlled rotational movement relative to each other. The rotatable coupler 204 may be driven by the drive motor 202. In some embodiments, the drive motor 202 is a worm gear drive shaft that drives the rotatable coupler 204. In other embodiments, the drive motor 202 is a spur gear. In some embodiments, the rotatable coupler 204 to (e.g., the slew ring) has a gearing interface to cooperatively couple to the drive motor 202. As the drive motor 202 is actuated (electrically, hydraulically, pneumatically, etc.), it drives the rotatable coupler 204 through the meshed gears. This interface causes the rotatable coupler 204 to rotate (e.g., the second ring 207 to rotate) which causes the upper portion coupled to the second ring 207 to rotate independently about the lower portion 211 of the vehicle 200. In various embodiments, the upper portion (e.g., the body pivotally coupled to the chassis) may rotate continuously a full 360° relative to the lower portion (e.g., the chassis).

In some embodiments, the drive motor 202 is electric and powered by the one or more of the low/high voltage batteries of the vehicle 200. In this embodiment, the drive motor 202 may comprise a stator and a rotor, which rotate concentrically when an electrical current is passed through the components. In other embodiments, the drive motor 202 is a hydraulic motor, driven by a differential in hydraulic pressure between two cavities in the drive motor 202. In such an embodiment, the hydraulic line 228 may be a supply line which supplies a high-pressure hydraulic fluid from the control valve 216 to the drive motor 202 to actuate the drive motor 202. The hydraulic line 226 may be a return line from the drive motor 202 to return the hydraulic fluid back to the control valve 216. The hydraulic line 222 may hydraulically couple the control valve 216 to a hydraulic pump (such as may be included in the power module 218) to increase the pressure of the hydraulic fluid. The hydraulic line 224 may couple the control valve 216 to a hydraulic reservoir (such as may be included in a power module 218). The hydraulic line 230 may hydraulically couple the control valve 216 to a control valve 220. In some embodiments, the hydraulic pump may have a capacity of approximately 3.15 cc/rev with a rated pressure of approximately 95 bar.

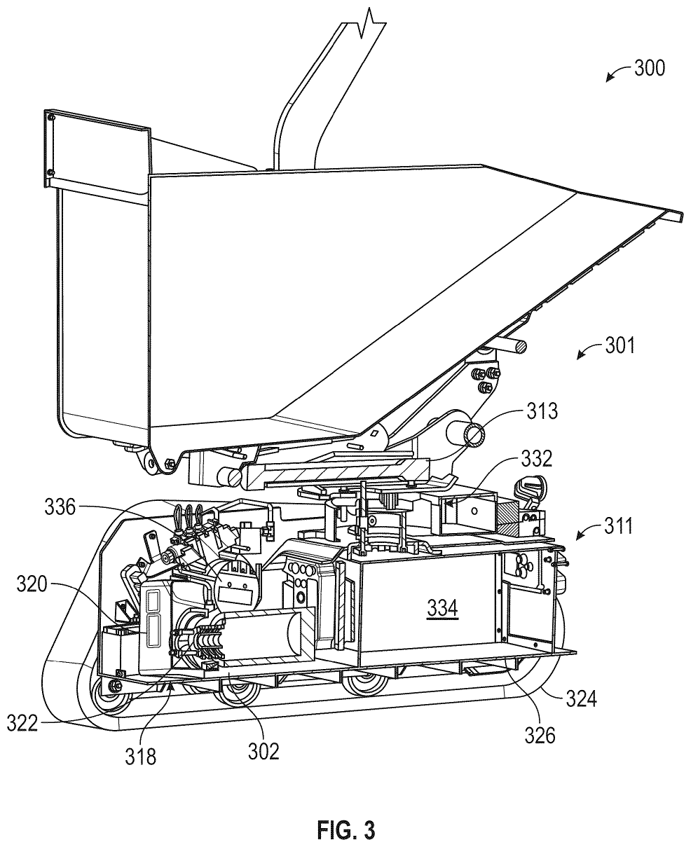

The power module 218 may include a hydraulic reservoir, a hydraulic pump, and a motor, as shown in FIG. 3.

Turning now to FIG. 3, a section view of a vehicle 300 is shown. In some embodiments, the vehicle 300 is substantially similar to the vehicle 100. The vehicle 300 may include a power module 318, a battery compartment 334, a lower portion 311, an upper portion 301, a drive motor 335, a rotatable coupler 332, and one or more actuators 313.

The power module 318 may be a subsystem of a hydraulic system onboard the vehicle 300. The power module 318 may include a hydraulic reservoir 320, a hydraulic pump 322, and a motor 302. The hydraulic reservoir 320 may be a tank or other holding vessel that collects the hydraulic fluid used in the hydraulic system of the vehicle 300. The hydraulic pump 322 pumps hydraulic fluid out of the hydraulic reservoir 320 to be pressurized and sent throughout the hydraulic system of the vehicle 300. The motor 302 is electrically actuated and is used to actuate the hydraulic pump 322. The hydraulic fluid is passed through various hydraulic lines and control valves to actuate various components of the vehicle 300. For example, the hydraulic fluid may actuate the one or more actuators 313 to move one or more components of the upper portion 301 or the lower portion 311. The hydraulic fluid may also actuate a drive motor of the rotatable coupler 332 to rotate the upper portion 301. In some embodiments, the hydraulic lines pass through the center of the rotatable coupler 332 to the one or more actuators 313.

The vehicle 300 may also include the drive motor 336. The drive motor 336 may be an electrical motor or hydraulic motor. In an embodiment in which the drive motor 336 is an electric motor, the drive motor 336 is driven by one or more of the low/high voltage batteries. The one or more low/high voltage batteries may be electrically coupled to the drive motor 336 to supply the drive motor 336 with electrical power to actuate the drive motor 336. In an electric configuration, the drive motor 336 may include a stator and a rotor.

The drive motor 336 may also or alternatively be a hydraulic drive motor 336. In a configuration of the drive motor 336, the drive motor 336 may be coupled to one or more of the hydraulic lines of the hydraulic system of the vehicle 300. In such an embodiment the power module may supply control valve with pressurized hydraulic fluid. The hydraulic fluid may pass through the control valve to the drive motor 336 to actuate the drive motor 336 in either a forward or backward direction. In some embodiments the vehicle 300 includes more than one drive motor 336, wherein the more than one drive motors 336 independently control more than one tractive element 324. In this manner the vehicle 300 may be propelled in a forward and backward direction when the more than one drive motors 336 rotate in the same direction, but also to rotate clockwise or counterclockwise when the more than one tractive element 324 rotate in opposite directions.

The battery compartment 334 is a volume of space protected by one or more walls 326 in which a battery may be placed. The battery to be placed in the battery compartment 334 may be comprised of a single cell battery or several cells electrically coupled to each other. The one or more walls 326 may be positioned around the battery in order to protect the battery from damage or unintentional contact. Likewise, the one or more walls 326 may have thermal management components extending through them (e.g., liquid cooling, fans, air vents, etc.).

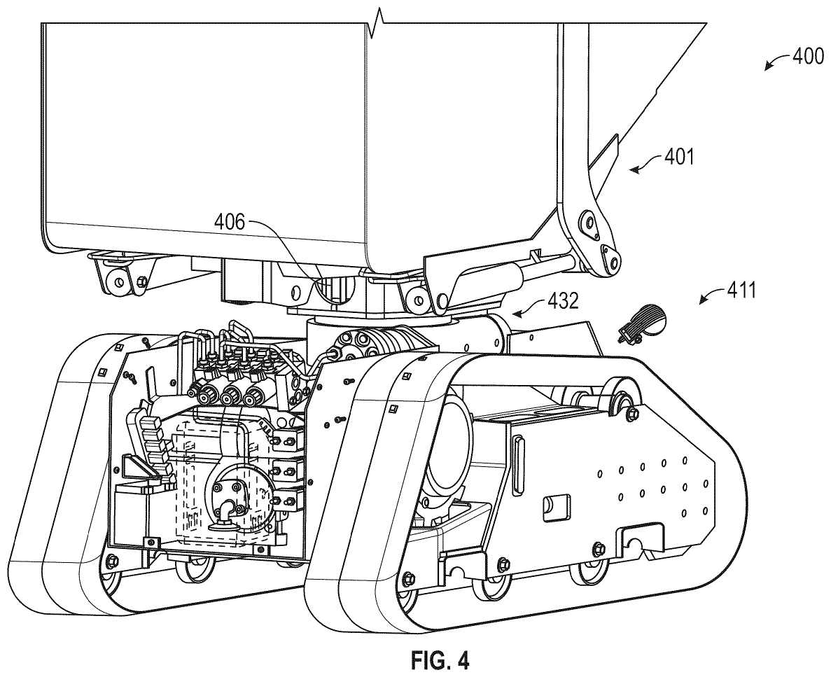

Turning now to FIG. 4, a rear, perspective view of a vehicle 400 is shown. In some embodiments, the vehicle 400 is substantially similar to the vehicle 100. The vehicle 400 may include an upper portion 401 and a lower portion 411. The upper portion 401 may be coupled to the lower portion 411 with one or more fasteners 406 (e.g., bolt, nail, screw, weld, solder, adhesive, etc.). A rotatable coupler 432 may be used in conjunction with the one or more fasteners 406 to rotatably couple the upper portion 4401 to the lower portion 411.

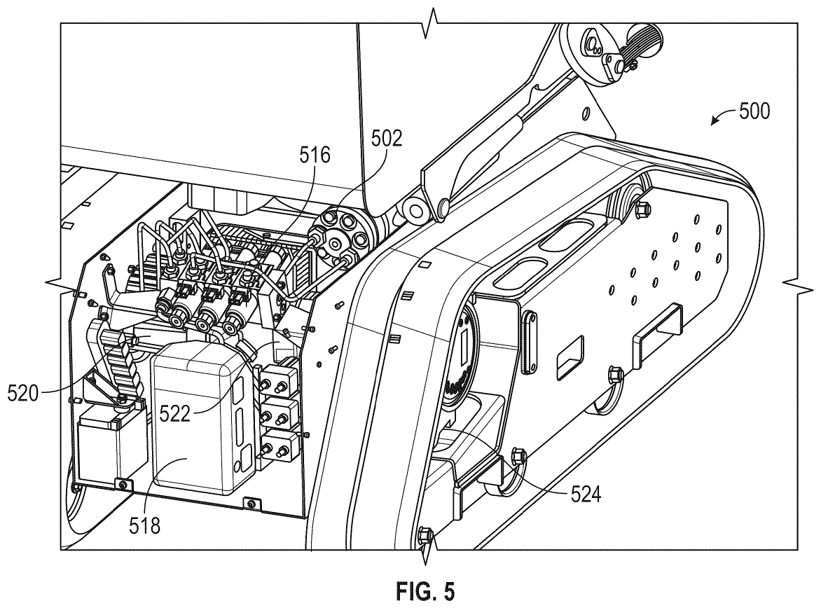

Turning now to FIG. 5, a rear, perspective view of a vehicle 500 is shown. In some embodiments, the vehicle 500 is substantially similar to the vehicle 100. The vehicle 500 may include a control valve 516, a drive motor 502, and a hydraulic reservoir 518. As shown, the vehicle 500 may include a first drive motor 520 and a second drive motor 522. The first drive motor 520 and the second drive motor 522 may have a shaft extending from a rotor (or a stator). The shaft may be coupled to a gear 524 or other interface for driving a tractive element (e.g., key, bearing, bolt, etc.).

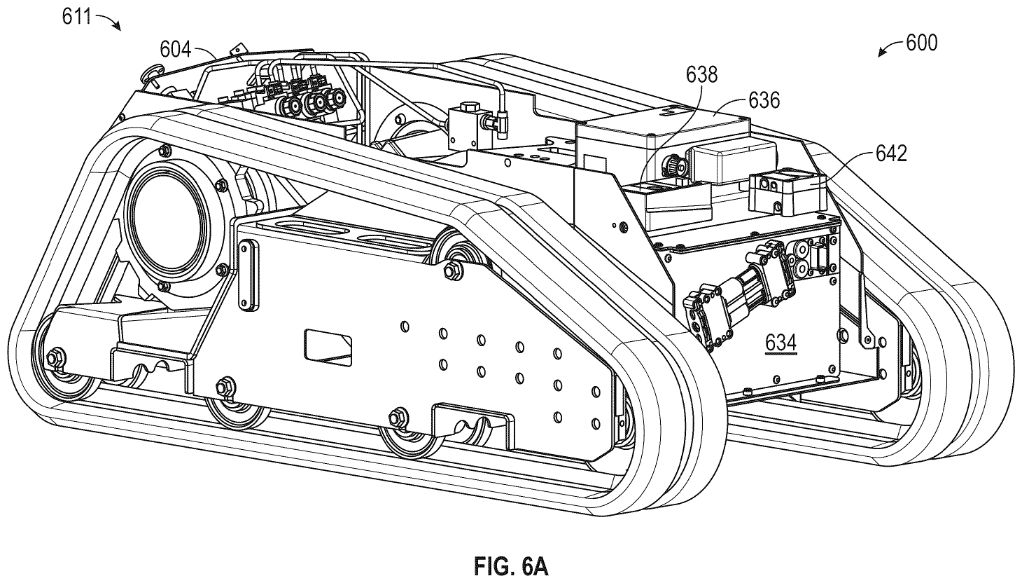

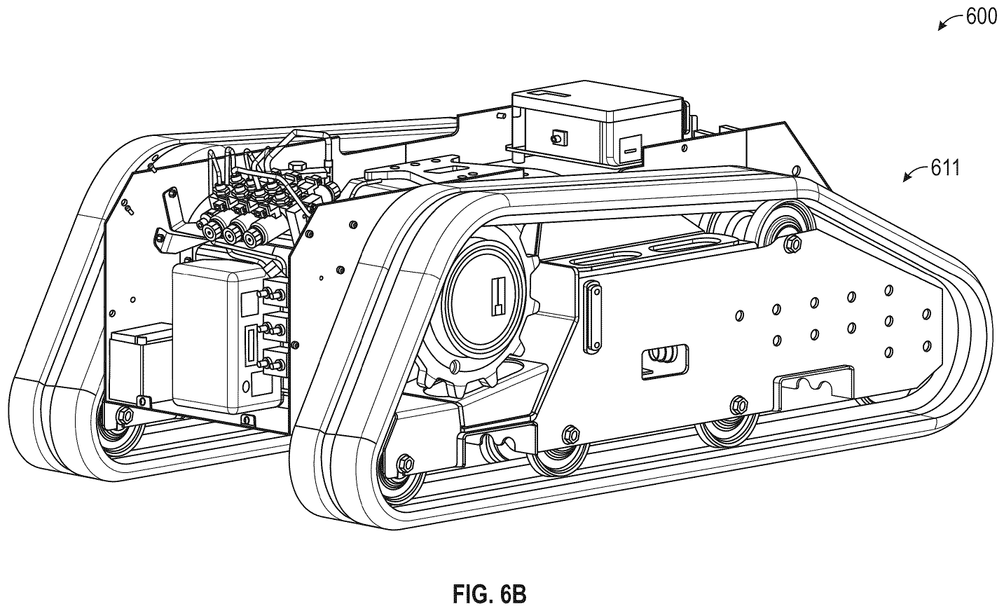

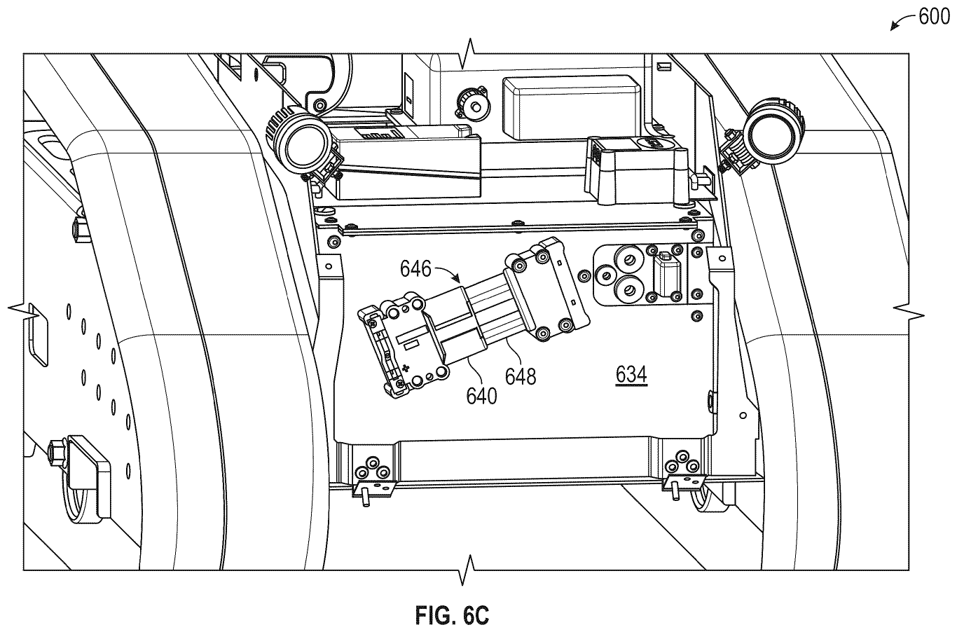

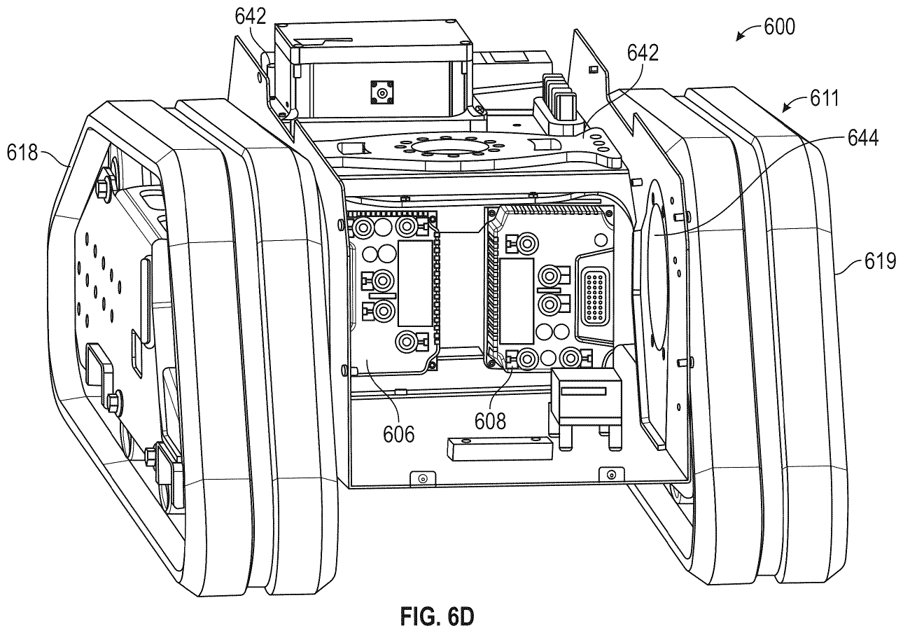

Turning now to FIG. 6A, a perspective view of a vehicle's 600 lower portion 611 is shown with a top portion hidden from view. In some embodiments, the vehicle 600 is substantially similar to the vehicle 100. The vehicle 600 may include an operator control panel 604, a battery charger 638, a wireless receiver 636, and a modem 642. In some embodiments, the wireless receiver 636 is communicably coupled to a user device (e.g., user device 116 of FIG. 1A). The wireless receiver 636 may be communicably coupled to the modem 642 to translate the wirelessly transmitted data from the user device to readable signals (e.g., analog, digital, etc.) to relay to the various subsystems (e.g., hydraulic, electrical, pneumatic, suspension, etc.) of the vehicle 600.

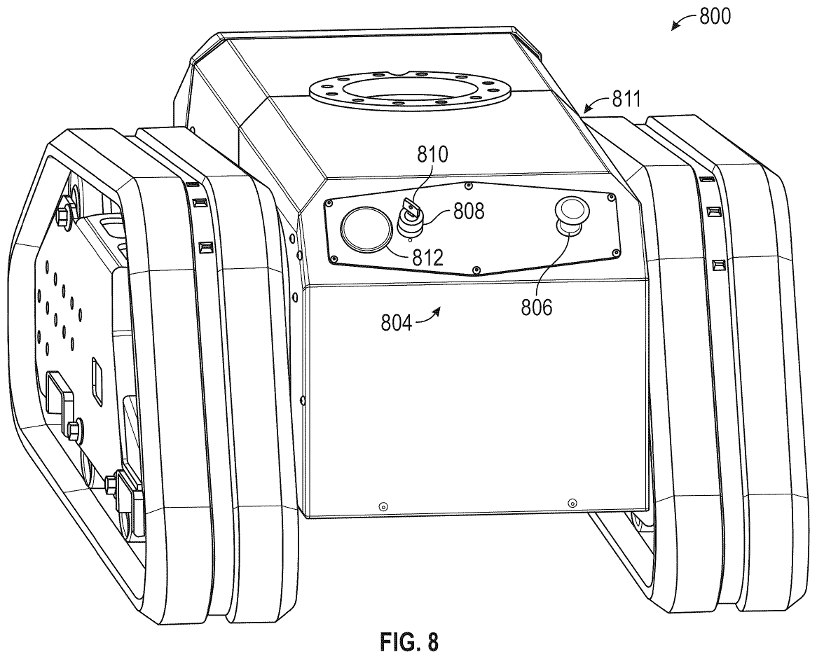

The operator control panel 604 may include a power switch, an ignition, a readout (e.g., analog dial, digital LCD screen, etc.), and one or more operator input devices. The operator control panel 604 may be similar to an operator control panel 804 of FIG. 8, as described therein.

Turning briefly now to FIG. 8, a perspective view of a vehicle 800 is shown. In some embodiments, the vehicle 800 is substantially similar to the vehicle 100. The vehicle 800 may include an operator control panel 804 positioned on a lower portion 811 of the vehicle 800. The operator control panel 804 may be used to switch the power state of the vehicle 800 and view certain data associated with the operation of the vehicle 800. For example, the operator control panel 804 may include one or more operator input devices 806 (e.g., buttons, sliders, dials, radio dials, touch screens, etc.) through which an operator of the vehicle 800 may control the vehicle 800. In one exemplary embodiment, the operator input device 806 is an emergency stop button (e.g., emergency shut-off control, etc.). Upon the operator interacting with (e.g., pressing) the operator input device 806, the vehicle 800 may stop operation and/or shut off. In some embodiments, the operator input device 806 is communicably coupled to one or more processors that execute one or more software protocols to adjust the function of the vehicle 800 (e.g., shutting off, changing speed, changing direction, etc.). In other embodiments, the operator input device 806 is a switch that may physically disconnect one or more subsystems from power (e.g., disconnecting a drive motor from a battery supply).

In some embodiments, the operator control panel 804 includes an ignition 808. The ignition 808 may be configured for initiating power to the vehicle 800. The ignition 808 may have a profiled entry into which a key 810 may be placed to enable operation of the vehicle 800. In some embodiments, the ignition 808 does not need a traditional, physical key to enable operation of the vehicle 800. In some embodiments, the key 810 is a device (e.g., keycard, fob, mobile device) which communicates wirelessly with the ignition 808 (e.g., NFC, Bluetooth, Zigbee, 5G, etc.) to enable operation of the vehicle 800. The ignition 808 may be configured to initiate a supply of power to the vehicle 800 by completing an electrical circuit when the ignition 808 is operated. In some embodiments, the operator input device 806 operates to override the ignition 808 to remove power from the vehicle 800.

The operator control panel 804 may also include a display 812. The display 812 may be any digital (e.g., LCD screen) or analog (e.g., dial) display used to convey information to an operator of the vehicle 800. For example, the display 812 may display operating hours, running temperature, battery voltage, etc. Additionally, or alternatively, the display 812 may have a selectable display in which the user may select what is displayed on the display 812.

Turning back now to FIG. 6B, a perspective view of a lower portion 611 of the vehicle 600 is shown. In some embodiments, the vehicle 600 is substantially similar to the vehicle 100. FIG. 6C illustrates a perspective view of the vehicle 600. In some embodiments, the vehicle 600 is substantially similar to the vehicle 100. The vehicle 600, in FIG. 6C, is shown without one or more body panels, which may be used for protecting the internal componentry of the vehicle 600. Vehicle 600 may include a battery compartment 634 to house one or more battery cells of the vehicle 600. The battery cells housed in the battery compartment 634 may be electrically coupled (e.g., by a wire of sufficiently large gauge) to a plug unit 646, which may comprise a plug 648 and a socket 640. The wire electrically coupled to the battery cells may be electrically coupled to the plug 648, the plug 648 being of an appropriate shape to interface with the socket 640 and thereby complete an electrical connection between the two components of the plug unit 646 (e.g., the plug 648 and socket 640). It should be understood that the battery cells may alternatively be coupled to the socket 640. In such embodiments, the socket 640 is electrically coupled to the high voltage components of the vehicle 600 (e.g., drive motors, pumps, etc.).

Turning now to FIG. 6D, a perspective view of the back of the lower portion 611 of the vehicle 600 is shown. In some embodiments, the vehicle 600 is substantially similar to the vehicle 100. The vehicle 600 may include one or more electronic control units (“ECUs”) 606, 608. The ECU 606 may be used to control one or more drive motors (e.g., drive motors 520, 522 of FIG. 5). These drive motors may be used to drive one or more tractive elements 618, 619. By way of example, the ECU 606 may be used to control a first drive motor which drives the tractive element 618. The ECU 608 may be used to control a second drive motor which drives the tractive element 619. In some embodiments, the ECU 606 drives the first drive motor independently of the ECU 608 driving the second drive motor. The ECUs 606, 608 are communicatively coupled to the modem 642 to receive the translated control signals from a user device. The ECUs 606, 608 then use those translated control signals to drive the first and second drive motors to execute the transmitted commands. In some embodiments, the vehicle 600 has only one ECU which is used to control all drive units in the vehicle 600. In some embodiments, the vehicle 600 has more than two drive motors and a dedicated ECU for each drive motor. In other embodiments, the vehicle 600 has only one ECU which is used to control all drive units of the vehicle 600. In other embodiments, there is an ECU to control all drive motors on each side of the vehicle 600.

Vehicle 600 may include at least one pass through 644, through which a shaft may pass to couple the drive motor to the tractive element 619. The pass through 644 may be an opening in the outer body of the lower portion 611 of the vehicle 600 that allows a shaft (e.g., a shaft of a drive motor) to engage with one or more gears which are used to propel the tractive element 619. In this way, the drive motors may be protected by the body of the vehicle 600 while maintaining functionality of driving the tractive elements 618, 619.

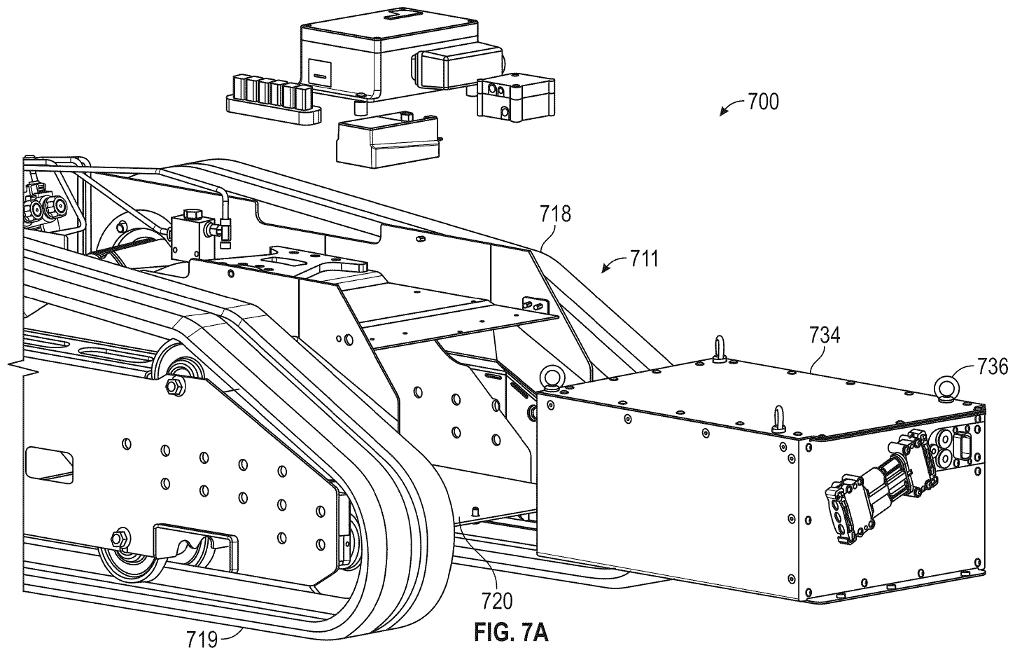

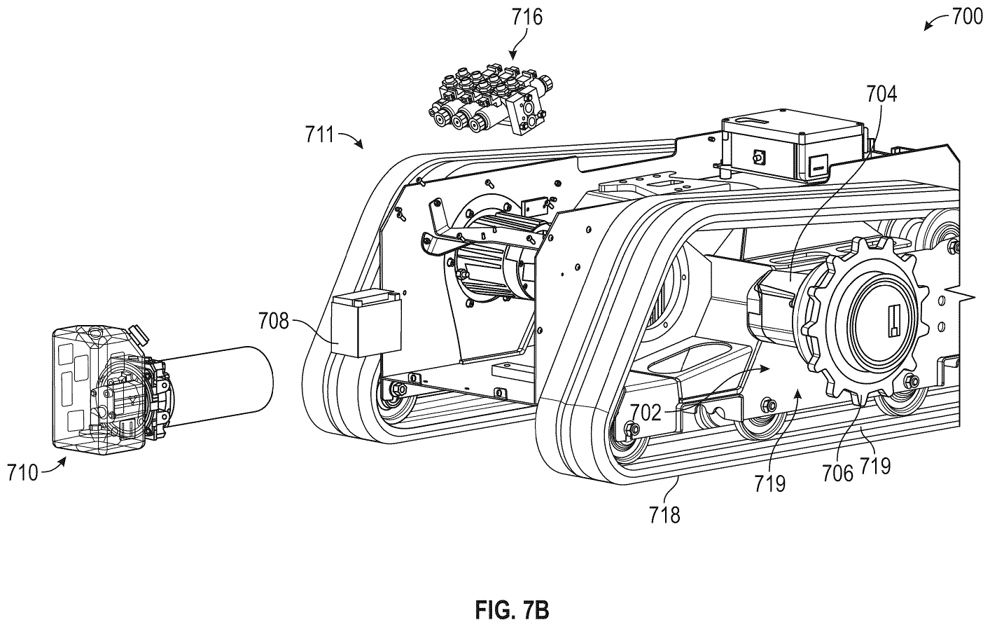

Turning now to FIG. 7A, a perspective, exploded view of a vehicle 700 is shown. In some embodiments, the vehicle 700 is substantially similar to the vehicle 100. The vehicle 700 may include a removable battery compartment 734. The removeable battery compartment 734 may include one or more mounting points 736, which may be used to lift/lower and/or otherwise transport the removeable battery compartment 734. In some embodiments, the removeable battery compartment 734 may be removed once the battery cells are depleted and a fully charged battery compartment placed in its stead. This allows for efficiently charge the battery compartment 734 while maintaining operability of the vehicle 700.

In some embodiments, various battery compartments 734 may be used with the vehicle 700. By way of example, different battery cell configurations with varying voltages or capacity may be used with the vehicle 700 to allow an operator to determine which battery to use with the vehicle 700. This may allow the operator to insert a smaller battery compartment 734 into the vehicle 700 to minimize a weight of the vehicle 700. Alternatively, or in addition, the operator may purchase a smaller battery compartment 734 to save on costs of the vehicle 700. When electrically coupled to the vehicle 700, the battery compartment 734 may be positioned entirely between the tractive elements 718 and on the floor 720 of the lower portion 711. This placement provides protection for the battery cells in the battery compartment 734 and a lower center of gravity for the vehicle 700.

The vehicle 700 may also include a controller. The controller may include one or more processors and one or more memory to control the various subsystems (e.g., electrical, hydraulic, pneumatic, suspension, etc.). The one or more processors, and any additional processing circuitry, may be used to execute instructions saved in the one or more memory to perform certain actions or transmit instructions the various subsystems to perform certain functions.

Turning now to FIG. 7B, a perspective, exploded view of the vehicle 700 is shown. In some embodiments, the vehicle 700 is substantially similar to the vehicle 100. The vehicle 700 may include a control valve 716, a power unit 710, a low voltage battery 708, and a drive unit 702.

The drive unit 702 may include a drive motor 704 and a tractive element interface 706. The drive motor 704 may be an electrical and/or hydraulic motor capable of rotating in both a clockwise and counterclockwise rotation. In a hydraulic configuration, the drive motor 704 is hydraulically coupled to the hydraulic subsystem (e.g., the control valve 716 and/or power unit 710). In an electrical configuration, the drive motor 704 is electrically coupled to the one or more of the low/high voltage battery systems onboard the vehicle 700. The drive motor 704 may include mounting positions to mount the tractive element interface 706. For example, the tractive element interface 706 may be bolted, welded, screwed, adhered, etc., to the mounting positions of the drive motor 704. The tractive element interface 706 may be positioned and shaped so as to cooperatively engage with one or more corresponding components on the tractive element 718. By way of example, the tractive element interface 706 may be a spur gear with a corresponding gear shape in an inner surface 719 of the tractive element 718. As the drive motor 704 drives the tractive element interface 706, the tractive element interface 706 engages with the inner surface 719 of the tractive element 718 and propels the vehicle 700. The vehicle 700 may have one or more drive units 702.

Turning now to FIG. 9, a top view of a user device 900 is shown. In some embodiments, the user device 900 is used to operate vehicle 901 in response to receiving controls from an operator interface. Vehicle 901 may be substantially similar to vehicle 100 of FIG. 1A. In some embodiments, the user device 900 is substantially similar to the user device 116 of FIG. 1A. The user device 900 may include a power selector 902, an emergency stop 904, an eco/power mode selector 906, a left track control 908, a right track control 910, a dump body rotation control 912, an operator display 914, one or more lights 916, and a dump body control 918.

The power selector 902 may be an operator input component with which the operator may turn the user device 900 “On” and “Off.” The emergency stop 904 may be used by the operator to remotely disable the vehicle 901. The eco/power mode selector 906 may be used by the operator to select between one or more operating modes. For example, the vehicle 901 may have a power mode in which the vehicle 901 maximizes power output from the drive motors. The vehicle 901 may also include an eco mode in which the vehicle 901 maximizes efficiency over power. The left track control 908 may be used to control one or more drive motors of the vehicle 901. In one embodiment the left track control 908 controls the drive motors that drive the left tractive element of the vehicle 901. The right track control 910 may be used to control one or more drive motors of the vehicle 901. In one embodiment the right track control 910 controls the drive motors that drive the right track development of the vehicle 901. The left track control 908 and the right track control 910 may be operated and adjusted independently of each other in order to operate the vehicle to propel forward, backward, rotate left, and rotate right. in some embodiments the vehicle 901 has wheels instead of tracks. In such an embodiment, the left track control 908 and the right track control 910 may be used to adjust a steering mechanism of the vehicle 901.

The dump body rotation control 912 may be used to transmit instructions to the vehicle 901 to rotate the upper body of the vehicle 901 about the lower portion of the vehicle 901. The dump body of the vehicle 901 may move independently of the lower portion of the vehicle 901. The dump body rotation control 912 of the user device 900 may transmit instructions to a drive motor of the vehicle 901 to actuate a slew ring or other rotatable coupler.

The dump body control 918 may be used by the operator to transmit instructions to the vehicle 901 to adjust a position of the dump body of the vehicle 901 in the bucket position of the vehicle 901. By way of example, selector 920 may cause the dump body of the vehicle 901 to dump, selector 922 may cause the dump body of the vehicle to return to a non-dumping position, selector 924 may be used to lower the bucket, and selector 926 may be used to raise the bucket into a loading position. It should be understood that components and the corresponding descriptions are provided for exemplary purposes only and should not be construed as limiting. The various components of the user device 900 may have different uses than those described herein. For example, the various controls and selectors may have varying purposes depending on the mode the user device is operating in (e.g., a vehicle control mode, a vehicle set up mode, a waypoint selector mode, etc.).

In some embodiments, the vehicle 901 may be semi-autonomous or fully autonomous.

The operator may select certain waypoints and/or paths for the vehicle 901 to travel between autonomously. For example, the operator may predefine on the user device 900 or another computing device (e.g., a mobile device, computer, tablet, etc.) a dig location at which the vehicle 901 may load material and a dump location at which the vehicle 901 may dump the material. Additionally, the user may select a point on a map (as displayed on the operator display 914, a mobile device, or other computing device) for the vehicle 901 to automatically travel, avoiding any obstacles that may be in the path. To accomplish this, the vehicle 901 may include various sensors (cameras, radar, LiDAR, infrared) and processing circuitry to receive the sensor data and generate a path to the selected location free of obstacles. The operator display 914 may be used to display pertinent information (e.g., vehicle 901 speed, battery level, temperature, connection strength, operating mode, etc.) to the operator of the user device 900.

Other instances of automated movements may include an automated material collection and arm return. In one embodiment, the operator may select an automated material collection and the vehicle 901 automatically lowers the arms to position the bucket in a scooping position and then moves forward to load the bucket. Once loaded, the arms lift to load the material in the dump body. Likewise, the operator may select an automated dump procedure, in which the dump body rotates to dump the material and arms of the vehicle 901 rotate to avoid interfering with the dumping motion or support surface.

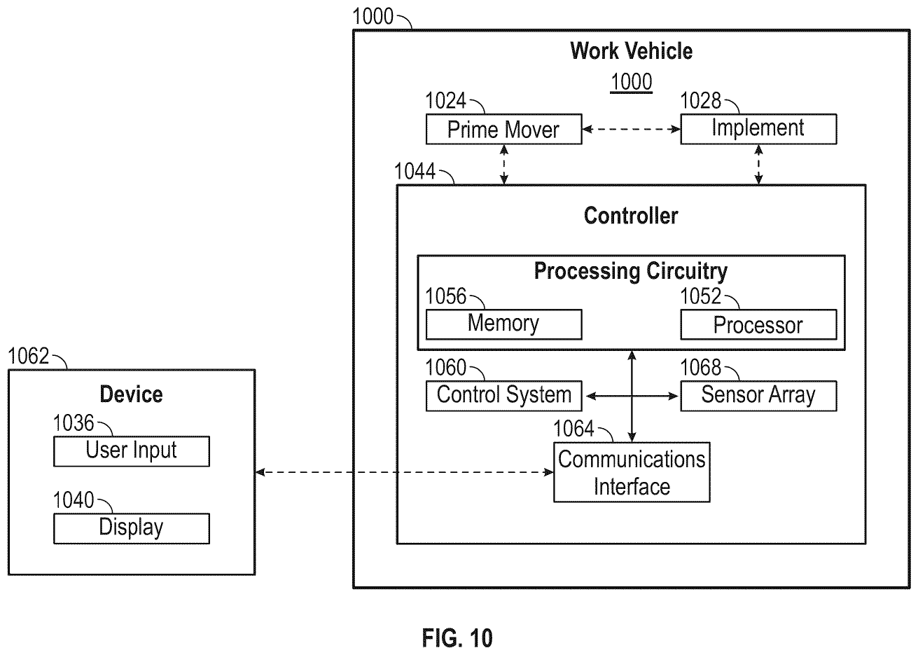

Turning now to FIG. 10, a block diagram of a vehicle 1000 is shown. The vehicle 1000 may include a prime mover 1024, an implement 1028, a controller 1044, processing circuitry, a memory device 1056, a processor 1052, a control system 1060, and a communications interface 1064. A user device 1062 may be communicably coupled to the vehicle 1000 through one or more wireless protocols, including through a network. The user device 1062 may include a user input 1036 and a display 1040. In some embodiments, the user device 1062 may be substantially similar to the user device 900 of FIG. 9.

Turning back to FIG. 10, the controller 1044 may be structured as one or more electronic control units (ECU). The controller 1044 may be separate from or included with at least one of an implement control unit, a powertrain control module, a motor control module, etc. In some embodiments, the controller 1044 includes a processing circuit 1048 having a processor(s) 1052 and a memory device 1056, a control system 1060, and a communications interface 1064. Generally, the controller 1044 is structured to receive inputs and generate outputs for or from a sensor array 1068 and user device 1062 (e.g., a load map, a machine-to-machine communication, a fleet management system, a user interface, a network, etc.) via the communications interface 1064.

The control system 1060 generates a range of inputs, outputs, and user interfaces. The inputs, outputs, and user interfaces may be related to at least one of a jobsite, a status of a piece of equipment, environmental conditions, equipment telematics, an equipment location, task instructions, sensor data, equipment consumables data (e.g. a fuel level, a condition of a battery), status, location, or sensor data from another connected piece of equipment or user device 1062, communications link availability and status, hazard information, positions of objects relative to a piece of equipment, device configuration data, part tracking data, text and graphic messages, weather alerts, equipment operation, maintenance, and service data, equipment beacon commands, tracking data, performance data, cost data, operating and idle time data, remote operation commands, reprogramming and reconfiguration data and commands, self-test commands and data, software as a service data and commands, advertising information, access control commands and data, onboard literature, machine software revision data, fleet management commands and data, logistics data, equipment inspection data including inspection of another piece of equipment using onboard sensors, prioritization of communication link use, predictive maintenance data, tagged consumable data, remote fault detection data, machine synchronization commands and data including cooperative operation of machines, equipment data bus information, operator notification data, work machine twinning displays, commands, and data, etc.

The sensor array 1068 can include physical and virtual sensors for determining work machine states, work machine conditions, work machine locations, loads, and location devices. In some embodiments, the sensor array includes a GPS device, a LiDAR location device, inertial navigation, or other sensors structured to determine a position of the vehicle 1000 relative to locations, maps, other equipment, objects, or other reference points. In an exemplary embodiment, the sensor array 1068 includes sensors configured to measure positions of the load materials and dump locations. In some embodiments, the sensor values are recorded at time intervals (e.g., 1 second, 1 microsecond, etc.). In some embodiments, the most recent or current sensor value may be compared to one or more prior sensor values stored in memory device 1056 to detect changes in position, orientation, location, status, or other criteria. In an exemplary embodiment, the recorded sensor data is processed using a set of instructions (e.g., instructions stored in memory device 1056) to process the stored sensor values into a meaningful equivalent for viewing by a user (e.g., operator, manager, dealer, etc.). For example, electronic sensors (e.g., transducers) may output sensed information in the form of an electronic signal (e.g., voltage, current, analog signal, digital signal, etc.) which may be processed by the processing circuit 1048, or by circuitry the sensor itself, to yield meaningful equivalents (e.g., position of a terminal end of the implement, an implement angle or position relative to another portion of the work equipment, temperature of a fluid, on/off status, etc.). The meaningful equivalents and/or the electronic signals may be viewable or accessible by the user through one or more displays 1040.

In one configuration, the control system 1060 is embodied as machine or computer-readable media that is executable by a processor, such as processor 1052. As described herein and amongst other uses, the machine-readable media facilitates performance of certain operations to enable reception and transmission of data. For example, the machine-readable media may provide an instruction (e.g., command, etc.) to acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the control system 1060 is embodied as hardware units, such as electronic control units. As such, the control system 1060 may be embodied as one or more circuitry components including, but not limited to, processing circuitry, network interfaces, peripheral devices, input devices, output devices, sensors, etc. In some embodiments, the control system 1060 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the control system 1060 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The control system 1060 may also include programmable hardware devices such as field programmable gate arrays, programmable array logic, programmable logic devices or the like.

The control system 1060 may include one or more memory devices for storing instructions that are executable by the processor(s) of the control system 1060. The one or more memory devices and processor(s) may have the same definition as provided below with respect to the memory device 1056 and processor 1052. In some hardware unit configurations, the control system 1060 may be geographically dispersed throughout separate locations in the vehicle 1000. Alternatively, and as shown, the control system 1060 may be embodied in or within a single unit/housing, which is shown as the controller 1044.

In the example shown, the controller 1044 includes the processing circuit 1048 having the processor 1052 and the memory device 1056. The processing circuit 1048 may be structured or configured to execute or implement the instructions, commands, and/or control processes described herein with respect to control system 1060. The depicted configuration represents the control system 1060 as machine or computer-readable media. However, as mentioned above, this illustration is not meant to be limiting as the present disclosure contemplates other embodiments where the control system 1060, or at least one circuit of the control system 1060, is configured as a hardware unit. All such combinations and variations are intended to fall within the scope of the present disclosure.

The hardware and data processing components used to implement the various processes, operations, illustrative logics, logical blocks, modules and circuits described in connection with the embodiments disclosed herein (e.g., the processor 1052) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., control system may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 1056 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 1056 may be communicably connected to the processor 1052 to provide computer code or instructions to the processor 1052 for executing at least some of the processes described herein. Moreover, the memory device 1056 may be or include tangible, non-transient volatile memory, or non-volatile memory. Accordingly, the memory device 1056 may include database components, object code components, script components, or any other type of information structure for supporting the various activities and information structures described herein.

In an exemplary embodiment, the memory device 1056 stores instructions for execution by the processor 1052 for a process to automatically generate a work site equipment grouping. The process to automatically generate a work site equipment grouping automatically associates vehicle 1000 connected on a near network to one or more other vehicles 1000. In some embodiments, the automatic associations are based on rules stored on a work machine or on another network node. In some embodiments, the association rules are based on one or more of a work site designation, a location of a machine, or a code (e.g., a customer key, a manufacturer key, or a maintainer key).

Although this description may discuss a specific order of method steps, the order of the steps may differ from what is outlined. Additionally, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is coupled to the processor to form a processing circuit and includes computer code for executing (e.g., by the processor) the one or more processes described herein.

It is important to note that the construction and arrangement of the electromechanical variable transmission as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other. substitutions, modifications, changes, and omissions may be made in the design, operating conditions, and arrangement of the preferred and other exemplary embodiments without departing from scope of the present disclosure or from the spirit of the appended claims.

What is claimed is:

1. A system comprising:
self-propelled cart comprising:
a chassis;
a body pivotally coupled to the chassis and configured to contain a volume of material;
an actuator configured to cause the body to rotate 360° relative to the chassis in a direction;
a tractive element coupled to the chassis;
a motor configured to drive the tractive element to propel the self-propelled cart; and
a controller operatively coupled to the motor and the actuator; and
a user device, wherein the user device is configured to transmit a control signal to the controller in response receiving instructions from an operator interface, and wherein the controller is configured to activate at least one of the actuator or the motor in response to receiving the control signal.

2. The system of claim 1, wherein the user device is configured to transmit the control signal wirelessly to the controller of the self-propelled cart to remotely control the self-propelled cart.

3. The system of claim 1, wherein the self-propelled cart is a buggy for loading and unloading construction material.

4. The system of claim 1, wherein the self-propelled cart does not include manual controls onboard the self-propelled cart.

5. The system of claim 1, wherein the tractive element is one of a tread, wheel, and track.

6. The system of claim 1, wherein the self-propelled cart further comprises a bucket coupled to a bottom portion of the body, the bucket configured to rotate relative to the body.

7. The system of claim 1, wherein the self-propelled cart further comprises a second actuator configured to rotate the body relative to the chassis in a second direction, wherein the second direction provides for dumping of the volume of material out of the body.

8. The system of claim 1, wherein the user device is a handheld remote control configured to remotely control one or more actions of the self-propelled cart.

9. The system of claim 1, wherein the self-propelled cart further comprises;
an ignition for initiating power to the self-propelled cart; and
an emergency shut-off control to override the ignition and remove power to the self-propelled cart.

10. The system of claim 1, wherein the self-propelled cart further comprises a slew ring coupling the body to the chassis, the slew ring configured to allow the body to rotate 360° about the chassis.

11. The system of claim 1, wherein the self-propelled cart further comprises a battery positioned below the body of the self-propelled cart and configured to provide power to the self-propelled cart.

12. The system of claim 11, the self-propelled cart further comprising a second tractive element, wherein the battery is positioned between the tractive element and the second tractive element.

13. A self-propelled cart comprising:
a chassis;
a body pivotally coupled to the chassis and configured to contain a volume of material;
an actuator configured to cause the body to rotate 360° relative to the chassis in a direction;
a tractive element coupled to the chassis;
a motor configured to drive the tractive element to propel the self-propelled cart; and
a controller operatively coupled to the motor and the actuator.

14. The self-propelled cart of claim 13, the self-propelled cart further comprising a second tractive element, wherein a battery for providing power to the self-propelled cart is positioned between the tractive element and the second tractive element.

15. The self-propelled cart of claim 13, wherein the self-propelled cart does not include manual controls onboard the self-propelled cart.

16. The self-propelled cart of claim 13, wherein the self-propelled cart further comprises a bucket coupled to a bottom portion of the body, the bucket configured to rotate relative the body.

17. The self-propelled cart of claim 13, wherein the self-propelled cart further comprises a second actuator configured to rotate the body relative to the chassis in a second direction, wherein the second direction provides for a dumping of the volume of material out of the body.

18. The self-propelled cart of claim 13, wherein the self-propelled cart further comprises;
an ignition for initiating power to the self-propelled cart; and
an emergency shut-off control to override the ignition and remove power to the self-propelled cart.

19. The self-propelled cart of claim 13, wherein the self-propelled cart further comprises a slew ring coupling the body to the chassis, the slew ring configured to allow the body to rotate 360° about the chassis.

20. A self-propelled cart comprising:
a chassis;
a body pivotally coupled to the chassis and configured to contain a volume of material;
a slew ring pivotally coupling the body to the chassis;
an actuator configured to cause the body to rotate 360° relative to the chassis in a direction;
a tractive element coupled to the chassis;
a motor configured to drive the tractive element to propel the self-propelled cart; and
a controller operatively coupled to the motor and the actuator.
